(19) United States
(12) Patent Application Publication
(10) Pub. No.: US 2019/0370803 A1
(43) Pub. Date: Dec. 5, 2019

(54) METHODS AND SYSTEMS FOR A ZERO-KNOWLEDGE CYBER-NOTARY

(71) Applicant: nsKnox Technologies LTD., Petach Tikva (IL)

(72) Inventors: Alon N. Cohen, Zichron Yaacov (IL); Ilan Shiber, Ganei Tikva (IL); Sagi Vizner, Netanya (IL); Yoav Hermon, Rishon LeTsion (IL)

(21) Appl. No.: 16/479,596

(22) PCT Filed: Jan. 24, 2017
(86) PCT No.: PCT/IL2017/050090

§ 371 Date: Jul. 21, 2019

(51) Int. Cl. G06Q 20/38; G06Q 20/40; G06Q 20/42

(52) U.S. Cl. CPC G06Q 20/38215; G06Q 20/425; G06Q 20/4016; G06Q 20/3827

(57) ABSTRACT

The present invention discloses methods and systems for a zero-knowledge cyber-notary. Methods include the steps of: upon receiving a request having details for performing a transaction, splitting the details into at least two data portions; independently sending at least two exclusive portions exclusively to each of at least two networks; wherein a given portion of a given network, is neither: sent nor accessible, neither whole nor in part; to another network other than the given network; upon each network independently identifying/authenticating a device associated with the request enabling the device to independently receive the portions from each network; enabling reassembly of the portions on the device to produce the details; enabling an approval/disapproval response of the request to be entered on the device; enabling independent transmittal of the response from the device to each network; and authorizing or declining the request based on the responses from at least two networks.

### FIELD AND BACKGROUND OF THE INVENTION

The present invention relates to methods and systems for a zero-knowledge cyber-notary for protecting digital transactions against various types of fraudulent activities. In particular, such methods and systems verify transaction content and approval by a third party having ‘zero knowledge_ about the transaction data itself.

In a world that is rapidly transitioning, traditional business activities are increasingly being performed digitally. Organizations are seeking to employ new payment mechanisms, and expand distribution channels into online, mobile, and international sectors.

Of course, with such widespread growth in the online industry comes an increasing number of threats in cybersecurity. Enabling such online transactions exposes commercial institutions to threats, such as a network breach that can compromise the transaction logs and credibility or customers' potentially denying the authenticity of transactions due to misunderstanding and fraud.

There are three main threats.

1. Computer Hacking
Hacking involves fraudulent and/or unauthorized transactions via the practice of modifying or altering computer software and/or hardware to accomplish a goal that is considered to be outside of the realm of the creator's or administrator's original objective. Such a case might be a hacker who breaches a bank network, alter the transaction logs, and create a misrepresentation of its account balance.

2. Chargebacks (examples below refer to credit-card fraud)
a. True Fraud—also called identity theft, occurs when a business accepts payment from a stolen card. The customer disputes the purchase, which results in his or her bank closing the account, and issuing a new account number and card to the customer.
b. Chargeback Fraud—involves an invalid use of chargeback rights by a cardholder. A purposeful misapplication of these rights in an effort for a customer to, so to speak, have their cake and eat it, too. The goal of the dispute is to keep the product or service acquired while enjoying a refund of the transaction amount. A misapplication of chargeback rights isn't always intentional and malicious. Such fraud occurs when a cardholder disputes a purchase because the cardholder forgot that the purchase was made, another family member authorized the purchase, or the cardholder even misunderstood the return policy. Such customers aren't trying to be deceitful—that differentiation is key. According to Visa, online merchants lost $11.8 billion to cases of such fraud in 2012.

3. Insider Fraud
Insiders pose a substantial threat to financial-service companies by virtue of their knowledge of, and access to, proprietary systems, and their ability to bypass security measures through legitimate means. Insider fraud is perpetrated by a malicious insider, someone such as a current or former employee, contractor, or other business partner, who currently has or previously had authorized access to an organization's network, system, or data. Such insiders intentionally exceed or misuse their access in a manner that negatively affects the confidentiality, integrity, and/or availability of the organization's information or information systems.

While some of these scenarios have different solutions (e.g., multi factor authentication—potentially helpful in countering true fraud, but not so much in dealing with chargeback fraud, or enforcing internal-security flow—which can safeguard from insider fraud, but wont help protecting systems from network hacking), a comprehensive solution for the different scenarios is not presently available.

It would be desirable to have methods and systems for a zero-knowledge cyber-notary for protecting digital transactions against various types of fraudulent activities. Such methods and systems would, inter alia, overcome the various limitations mentioned above.

### SUMMARY

It is the purpose of the present invention to provide methods and systems for a zero-knowledge cyber-notary for protecting digital transactions.

It is noted that the term ‘exemplary_ is used herein to refer to examples of embodiments and/or implementations, and is not meant to necessarily convey a more-desirable use-case. Similarly, the terms ‘alternative_ and ‘alternatively_ are used herein to refer to an example out of an assortment of contemplated embodiments and/or implementations, and is not meant to necessarily convey a more-desirable use-case. Therefore, it is understood from the above that ‘exemplary_ and ‘alternative_ may be applied herein to multiple embodiments and/or implementations. Various combinations of such alternative and/or exemplary embodiments are al so contemplated herein.

For purposes of clarity, several terms are defined herein. The term ‘partner networks_ is used herein to refer to multiple, independent networks in which the term ‘independent_ is used in order to emphasize that each partner is a separate entity with its own secure infrastructure and personnel, and does not depend or rely in any way on any other partner network. The term ‘cyber-notary_ is used herein to refer to a transaction authority which utilizes independent, partner networks having zero knowledge of the transactions to securely approve and authenticate such transactions.

Embodiments of the present invention utilize trusted third parties to authenticate the transaction parties (both the transaction provider and the transaction consumer), verify the transaction details, and provide an external and independent copy of the transaction that cannot be altered even if the transaction-provider network is breached, while the trusted third parties remain completely ‘blind_ (i.e., have zero knowledge) to the transaction data itself. Such a transaction-process functionality is referred to herein as serving as a ‘cyber-notary._

Such cyber-notary capabilities are achieved by using an array of external networks (i.e., external to the transaction-provider network) in order to collectively accomplish the above aspects of a transaction authority.

Consider the scenario in which a user (i.e., a transaction consumer) wants to make a financial transaction (e.g., purchase capital-market stocks) at a bank (i.e., a transaction provider) using the banks network (i.e., a transaction-provider network). The user performs the transaction over the banks online system. The user decides which stocks to purchase, the amount of stock, an agreeable purchase price, and any other ‘transaction parameters_ required to perform the transaction. The user approves the order, and the bank executes the transaction. Such a simple transaction scenario is exposed to potential fraud as mentioned above.

The user can deny aspects of the transaction at a later time (for true or false reasons), such as denying he or she requested the transaction, or denying some of the transaction details (e.g., ‘the purchase was for 1,000 shares, not 100 shares_). In such a case, the bank needs to prove the authenticity of the user and of the transaction details. This can be problematic for several reasons.
1. The bank itself is a party in the dispute, and thus has an inherent conflict of interest to misrepresent the true situation. Even if the bank doesn't misrepresent the facts, such a conflict of interest can damage the bank's credibility.
2. The bank saves the transaction details inside its network within its computer infrastructure, which (like every computer infrastructure) is susceptible to a data breach and/or the altering of data and logs, specifically transaction logs. Such a data breach can be performed by a hacker or even by the transaction consumer. Most importantly, as data breaches become increasingly sophisticated and harder to detect, organizations frequently detect such breaches long after their occurrence (if at all). Such a reality complicates the task of the bank proving, without a reasonable doubt, that no such breach occurred, and that the transaction logs can be fully relied on.

As mentioned above, another potential scenario involves a specific transaction not even originating from a valid user, but from an insider (e.g., a bank employee) who forges transactions on behalf of real users, or a hacker who alters system logs and databases to create the appearance of genuine transactions.

Embodiments of the present invention provide various security features and benefits beyond state-of-the-art security techniques. Such features and benefits include the following aspects.
Additional Authentication Factor—in which the cyber-notary (i.e., the combined activity of the independent, partner networks) identifies the consumer independently from the transaction provider, meaning that the consumer had to identify itself to the transaction provider (using its own methods), and also to each of the independent, partner networks (as detailed below), thereby providing more credibility to the authenticity of the consumer.
Non-Repudiation Using External Transaction Log—in the event that one of the parties (the transaction provider/consumer) repudiates the transaction itself or the transaction details, the transaction can be checked by a third party (e.g., the cyber-notary) which saves an external log of the transaction. The third party is not biased, and has no interest in misrepresenting the true transaction.
Zero Knowledge—in which the external parties have zero knowledge of the transaction data, which is very important for confidential transaction data that the transaction provider doesn't want to expose to other parties, as well as in cases in which regulations and/or laws deny the transaction provider from doing so.
Malicious Data-Manipulation Detection/Prevention—in which a hacker cannot alter transaction information in the partner networks even by hacking into the transaction-provider network, making it impossible to change transaction data without being detected (i.e., altered data wont match the transaction data residing in the partner networks), and impossible to create new, fake transactions having matching transaction data in the partner networks.
Redundant Protection—in which a hacker has no knowledge about the transaction itself if a single, partner network is breached, and cannot alter the transaction without being detected. Moreover, a single partner network cannot maliciously create a false representation by changing its own portion of the transaction details in order to make claims by the transaction provider or the transaction consumer seem deceitful.
False/Manipulated Transaction Detection—in which executed transactions are verified as real and genuine transactions. In the instance that a transaction is suspected of being fake, the transaction provider checks for a matching transaction in the partner networks (i.e., using a unique link to retrieve the data portions, decrypting the data, and matching the decrypted data to the actual transaction as detailed below). Such a verification process can be performed periodically (e.g., at the end of each day, match the executed transactions with their corresponding representations in the partner networks).
Internal/Privileged Fraud Detection/Prevention—in which transactions cannot be falsified using internal-user permissions, since falsified data would have to be created at each of the partner networks.
Fraud Detection—in which a consumer will find it harder to deny a transaction, since the consumer approved the transaction to the transaction provider as well as to the partner networks. The consumer also approved the exact content to both the transaction provider and the partner networks. The transaction provider cant maliciously alter the transaction content after the consumers approval since the content is saved on the partner networks, thereby giving the transaction provider greater credibility in the event of a dispute.

Therefore, according to the present invention, there is provided for the first time a method for protecting digital transactions using a zero-knowledge cyber-notary, the method including the steps of: (a) upon receiving a transaction request for securely performing a transaction wherein the transaction request includes transaction details, cryptographically splitting the transaction details into at least two data portions; (b) independently sending at least two exclusive unique portions of at least two data portions exclusively to each of an array of at least two independent partner networks; wherein a given exclusive unique portion, of at least two exclusive unique portions, of a given independent partner network, is neither: (i) sent, neither whole nor in part, to another independent partner network other than the given independent partner network; nor (ii) accessible, neither whole nor in part, to another independent partner network other than the given independent partner network; (c) upon each independent partner network of the array independently identifying and authenticating a transaction consumer device associated with the transaction request, enabling the transaction consumer device to independently receive at least two data portions from each independent partner network of the array; (d) enabling reassembly of at least two data portions on the transaction consumer device to produce the transaction details; (e) enabling an approval/disapproval response of the transaction request to be entered on the transaction consumer device; (f) enabling independent transmittal of the approval/disapproval response from the transaction consumer device to each independent partner network of the array; (g) authorizing the transaction request based on receiving approval responses from an approval subset of at least two said approval/disapproval responses said at least two independent partner networks of said array; and (h) declining the transaction request based on receiving disapproval responses from a disapproval subset of at least two approval/disapproval responses from at least two independent partner networks of the array.

Alternatively, the step of cryptographically splitting includes splitting the transaction details into at least two data portions which employs Optimal Asymmetric Encryption Padding (OAEP) by adding random padding to a byte array of the transaction details.

Most alternatively, the step of cryptographically splitting further includes performing a XOR operation between a random data array and a transaction array of the byte array with the random padding.

Alternatively, each independent partner network neither receives nor has access to, neither whole nor in part, to the transaction details.

Alternatively, the reassembly of at least two data portions into the transaction details requires all the data portions from each independent partner network of the array.

Alternatively, any data portion cannot be modified by any independent partner network of the array without being detected.

Alternatively, the step of independently sending includes independently sending a given, unique hash signature, of another independent partner network other than the given independent partner network, to the given independent partner network.

Alternatively, the step of authorizing and the step of declining are based on obtaining a final transaction authorization/denial, and wherein the final transaction authorization/denial includes multiple approval/disapproval responses, associated with more than one transaction request, from at least a critical subset of authorizing transaction consumers who received or initiated identical transaction requests for a given transaction.

Alternatively, the method further including the step of: (i) enabling subsequent reassembly of at least two data portions for a historical transaction record to produce the transaction details of the historical transaction record.

According to the present invention, there is provided for the first time a system for protecting digital transactions using a zero-knowledge cyber-notary, the system including: (a) a CPU for performing computational operations; (b) a memory module for storing data; (c) a network connection for communicating across a data-exchange protocol system; and (d) a cyber-notary module configured for: (i) upon receiving a transaction request for securely performing a transaction wherein the transaction request includes transaction details, cryptographically splitting the transaction details into at least two data portions; (ii) independently sending at least two exclusive unique portions of at least two data portions exclusively to each of an array of at least two independent partner networks; wherein a given exclusive unique portion, of at least two exclusive unique portions, of a given independent partner network, is neither: (A) sent, neither whole nor in part, to another independent partner network other than the given independent partner network; nor (B) accessible, neither whole nor in part, to another independent partner network other than the given independent partner network; (iii) upon each independent partner network of the array independently identifying and authenticating a transaction consumer device associated with the transaction request, enabling the transaction consumer device to independently receive at least two data portions from each independent partner network of the array; (iv) enabling reassembly of at least two data portions on the transaction consumer device to produce the transaction details; (v) enabling an approval/disapproval response of the transaction request to be entered on the transaction consumer device; (vi) enabling independent transmittal of the approval/disapproval response from the transaction consumer device to each independent partner network of the array; (vii) authorizing the transaction request based on receiving approval responses from an approval subset of at least two approval/disapproval responses from at least two independent partner networks of the array; and (viii) declining the transaction request based on receiving disapproval responses from a disapproval subset of at least two approval/disapproval responses from at least two independent partner networks of the array.

Alternatively, the cryptographically splitting includes splitting the transaction details into at least two data portions which employs Optimal Asymmetric Encryption Padding (OAEP) by adding random padding to a byte array of the transaction details.

Most alternatively, the cryptographically splitting further includes performing a XOR operation between a random data array and a transaction array of the byte array with the random padding.

Alternatively, each independent partner network neither receives nor has access to, neither whole nor in part, to the transaction details.

Alternatively, the reassembly of at least two data portions into the transaction details requires all the data portions from each independent partner network of the array.

Alternatively, any data portion cannot be modified by any independent partner network of the array without being detected.

Alternatively, the independently sending includes independently sending a given, unique hash signature, of another independent partner network other than the given independent partner network, to the given independent partner network.

Alternatively, the authorizing and the declining are based on obtaining a final transaction authorization/denial, and wherein the final transaction authorization/denial includes multiple approval/disapproval responses, associated with more than one transaction request, from at least a critical subset of authorizing transaction consumers who received or initiated identical transaction requests for a given transaction.

Alternatively, the cyber-notary module is further configured for: (ix) enabling subsequent reassembly of at least two data portions for a historical transaction record to produce the transaction details of the historical transaction record.

According to the present invention, there is provided for the first time a non-transitory computer-readable storage medium, having computer-readable code embodied on the non-transitory computer-readable storage medium, for protecting digital transactions using a zero-knowledge cyber-notary, the computer-readable code including: (a) program code for, upon receiving a transaction request for securely performing a transaction wherein the transaction request includes transaction details, cryptographically splitting the transaction details into at least two data portions; (b) program code for independently sending at least two exclusive unique portions of at least two data portions exclusively to each of an array of at least two independent partner networks; wherein a given exclusive unique portion, of at least two exclusive unique portions, of a given independent partner network, is neither: (i) sent, neither whole nor in part, to another independent partner network other than the given independent partner network; nor (ii) accessible, neither whole nor in part, to another independent partner network other than the given independent partner network; (c) program code for, upon each independent partner network of the array independently identifying and authenticating a transaction consumer device associated with the transaction request, enabling the transaction consumer device to independently receive at least two data portions from each independent partner network of the array; (d) program code for enabling reassembly of at least two data portions on the transaction consumer device to produce the transaction details; (e) program code for enabling an approval/disapproval response of the transaction request to be entered on the transaction consumer device; (f) program code for enabling independent transmittal of the approval/disapproval response from the transaction consumer device to each independent partner network of the array; (g) program code for authorizing the transaction request based on receiving approval responses from an approval subset of at least two approval/disapproval responses from at least two independent partner networks of the array; and (h) program code for declining the transaction request based on receiving disapproval responses from a disapproval subset of at least two approval/disapproval responses from at least two independent partner networks of the array.

Alternatively, the cryptographically splitting includes splitting the transaction details into at least two data portions which employs Optimal Asymmetric Encryption Padding (OAEP) by adding random padding to a byte array of the transaction details.

Most alternatively, the cryptographically splitting further includes performing a XOR operation between a random data array and a transaction array of the byte array with the random padding.

Alternatively, each independent partner network neither receives nor has access to, neither whole nor in part, to the transaction details.

Alternatively, the reassembly of at least two data portions into the transaction details requires all the data portions from each independent partner network of the array.

Alternatively, any data portion cannot be modified by any independent partner network of the array without being detected.

Alternatively, the independently sending includes independently sending a given, unique hash signature, of another independent partner network other than the given independent partner network, to the given independent partner network.

Alternatively, the authorizing and the declining are based on obtaining a final transaction authorization/denial, and wherein the final transaction authorization/denial includes multiple the approval/disapproval responses, associated with more than one transaction request, from at least a critical subset of authorizing transaction consumers who received or initiated identical transaction requests for a given transaction.

Alternatively, the computer-readable code further includes: (i) program code for enabling subsequent reassembly of at least two data portions for a historical transaction record to produce the transaction details of the historical transaction record.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified high-level schematic diagram of a typical system architecture for a zero-knowledge cyber-notary for protecting digital transactions using independent, partner networks, according to embodiments of the present invention;

FIG. 2 is a simplified flowchart of the major process steps for transaction approval via a zero-knowledge cyber-notary using independent, partner networks, according to embodiments of the present invention.

### DESCRIPTION OF THE ILLUSTRATIVE EMBODIMENTS

The present invention relates to methods and systems for a zero-knowledge cyber-notary for protecting digital transactions. The principles and operation for providing such methods and systems, according to the present invention, may be better understood with reference to the accompanying description and the drawings.

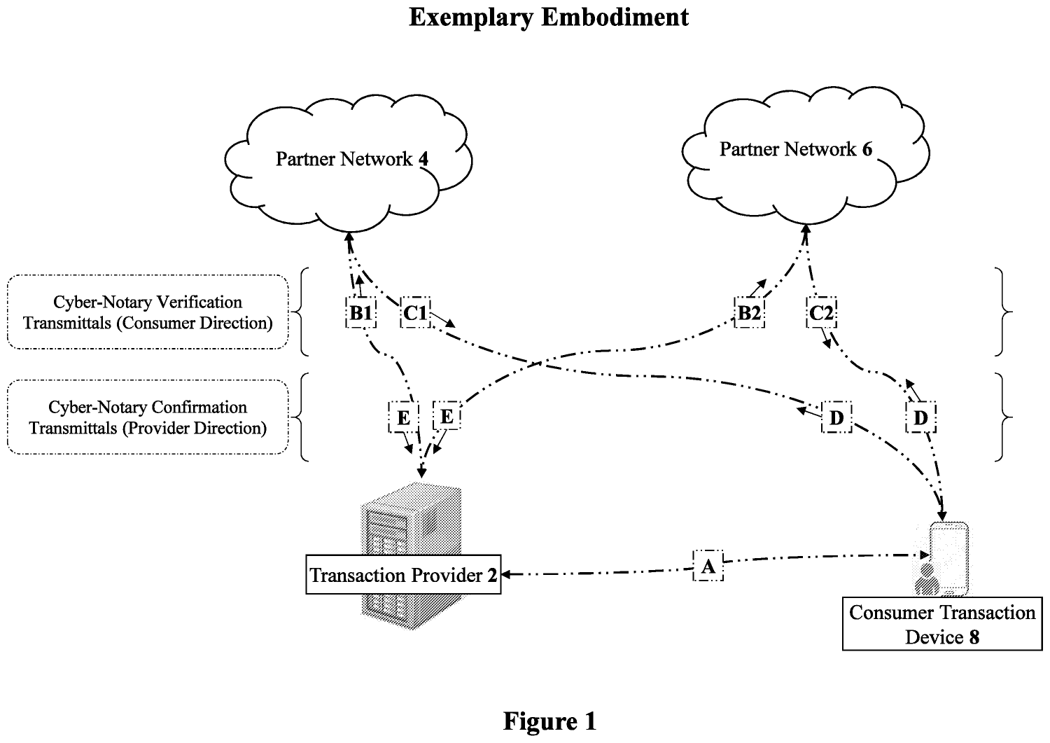

Referring to the drawings, FIG. 1 is a simplified high-level schematic diagram of a typical system architecture for a zero-knowledge cyber-notary for protecting digital transactions using independent, partner networks, according to embodiments of the present invention.

A transaction provider 2 serves to initiate and engage the partner networks, which in turn manages the cyber-notary process. Transaction provider 2 is operationally connected independently to each of independent, partner networks 4 and 6 and to a consumer transaction device 8 (e.g., a network-enabled smartphone, PC, laptop, tablet, or dedicated transaction device running a cyber-notary program). Consumer transaction device 8 can also be an automated and integrated third-party system processing transactions in a B2B context.

The functionality of independent, partner networks 4 and 6 can be considered collectively as a cyber notary. In the exemplary embodiment of FIG. 1, two partner networks are shown; however, the number of partner networks implemented may be increased based on security requirements and limitations.

FIG. 1 also schematically depicts ‘Transaction-Path Segments_ to indicate different parts of the cyber-notary process and the process-flow directions. Transaction-Path Segment A involves transaction initiation by the consumer, and conveying the transaction details to transaction provider 2. This can be considered a ‘provisionally-authorized_ cyber-notary step in that it is the only part of the overall process that involves direct communication between consumer transaction device 8 and transaction provider 2.

Transaction-Path Segments B1 and B2 involve transaction provider 2 independently sending portions of the transaction details to partner networks 4 and 6, respectively. In turn, Transaction-Path Segments C1 and C2 involve respective partner networks 4 and 6 independently sending their transaction-detail portions to consumer transaction device 8 via a cyber-notary app (i.e., the cyber-notary program) after consumer transaction device 8 had independently identified and authenticated itself to each of the partner networks (not shown). The cyber-notary app, residing on consumer transaction device 8, is administered and managed by transaction provider 2. Transaction-Path Segments B1, B2, C1, and C2 are collectively designated as ‘Cyber-Notary Verification Transmittals (Consumer Direction)_ in FIG. 1.

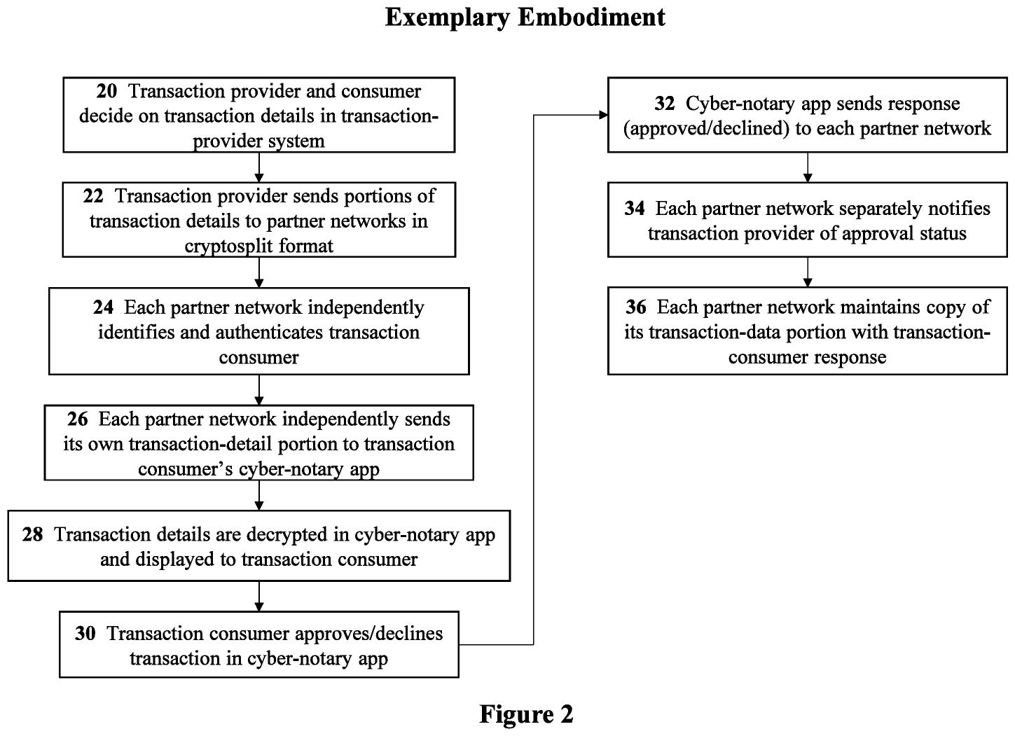

Upon consumer confirmation, the ‘second half_ of the process involves the transaction approval response (detailed below with regard to FIG. 2) flowing back from consumer transaction device 8, first to partner networks 4 and 6 (via Transaction-Path Segments D) and in turn to transaction provider 2 (via Transaction-Path Segments E). Transaction-Path Segments D and E are collectively designated as ‘Cyber-Notary Confirmation Transmittals (Provider Direction)._ Note that Transaction-Path Segments D and E aren't designated as ‘D1/D2_ and ‘E1/E2_ because unlike Transaction-Path Segments B1 and B2 (for example), Transaction-Path Segments D, for example, are duplicate copies of the approval response being sent to each of partner networks 4 and 6.

FIG. 2 is a simplified flowchart of the major process steps for transaction approval via a zero-knowledge cyber-notary using independent, partner networks, according to embodiments of the present invention.

The process starts when transaction provider 2 and the transaction consumer (via consumer transaction device 8) decide on the transaction details in the transaction-providers system (Step 20). It is noted that the consumer may communicate the transaction details by other means (e.g., verbal communication); however, ultimately the transaction details are authorized once they are entered into the cyber-notary program of transaction provider 2, and approved by the transaction consumer via the cyber-notary system.

Transaction provider 2 then independently sends portions of the transaction details to independent, partner networks 4 and 6 in a ‘cryptosplit_ format (Step 22). The transaction data is split by transaction provider 2 into parts with the number of parts corresponding to the number of independent partner networks.

The splitting process must meet the following conditions.
1. Each partner network holds no actual data about the transaction itself.
2. In order to reassemble the transaction data, all the different parts from the partner networks are required.
3. A specific partner network cannot become a fraudulent party by modifying its own stored, transaction-data portion in order to represent the transaction as different than initially submitted without being detected.

As an exemplary solution and implementation for the splitting process, assume there are N partner networks. If the transaction data is considered as an array of bytes, random padding can be added to the byte array. An exemplary cryptographic implementation could employ Optimal Asymmetric Encryption Padding (OAEP).

A random array of bytes could be generated having the same size as the transaction data. A xor operation could then be performed between the random array and the transaction array. By performing a xor operation, every bit of the data yields a complementary bit.

It is noted that such an example relates to N partner networks that would all have to be breached/legally accessed in order to gain access to the data. However, in some implementations, for the sake of high availability and performance, it is possible to use a larger number of partner networks (e.g., M partner networks, wherein M>N) in which the data parts are stored, and from which any subset of N partner networks could be selected for retrieving and reconstructing the original data. Such installation may use Shamir's secret-sharing scheme or similar schemes rather than xor operation as the basis for the cryptographic splitting.

To continue with the example, Step 22 of FIG. 2 would then need to be executed N−1 times (except for padding the data), producing N portions of the transaction data (e.g., P₁, P₂, \check{u}, Pₙ) with each portion containing no information about the original transaction. For each portion, a ‘signature_ of its content can be generated using a cryptographic hash function, yielding portion signatures (e.g., H₁, H₂, \check{u}, Hₙ).

A transaction portion, with another portion's unique hash signature, can then be independently sent to each partner network. It is important to note that integrity of the protocol is maintained by ensuring that a partner network doesn't receive its own portion signature, but rather the portion signature of another partner network. As an illustrative elaboration on this, a partner network i would receive Pᵢ and Hᵢ₊₁. The last partner network (i.e., N) would receive Pₙ and H₁. After this part of the overall cyber-notary process is complete, each partner network has a transaction portion (Pᵢ) and a different portion signature (Hᵢ₊₁).

There are instances in which the transaction data needs to be reassembled. For example, the transaction consumer needs to view the transaction data during the approval process, or later the transaction provider/consumer may want to verify old transactions. In such cases, the transaction data can be reassembled as follows. Continuing with the exemplary implementation, the transaction portions (P₁, P₂, \check{u}, Pₙ) and their corresponding signatures (H₁, H₂, \check{u}, Hₙ) are gathered from the partner networks. Each transaction portion (Pᵢ) is validated to match its portion signature (Hᵢ). The transaction is then reassembled by performing a xor operation on all the portions to compute the original transaction array with the padding. The padding can then be removed, producing the original transaction's byte-array representation.

Every partner network has no knowledge about the transaction data itself, since Pᵢ and Hᵢ₊₁ are meaningless without all the other portions and signatures. Note that Hᵢ₊₁ is the resultant of performing hash function, exposing the portion signatures to be potentially inverted using a brute-force attack. For such considerations, the padding implemented is significant. As the length (in bytes) of the padding is increases, so does the length of the byte array to be split as well as the length of each portion Pᵢ. With increasing portion length, it becomes increasingly harder to successfully hack the portions. Nowadays, such brute-force attacks of the resultants of common cryptographic hash functions, computed on long-enough values, are considered infeasible.

The portion signatures are important to achieve the third criterion defined above regarding the splitting process. Every partner network cannot become a fraudulent party by modifying its own stored, transaction-data portion (Pᵢ) because its portion signature is saved in a different partner network. Such an act would cause an incompatibility when trying to reassemble the transaction, meaning that a malicious party cannot alter a transaction without breaching all partner networks.

Returning to FIG. 2, once transaction provider 2 independently sends the transaction portions to independent, partner networks 4 and 6 (Step 22), the process continues with each of partner networks 4 and 6 independently identifying and authenticating the transaction consumer (Step 24). Thus, the transaction consumer is operationally connected and authenticated independently to each of partner networks 4 and 6, resulting in a high-quality authentication. This is especially so if each partner network uses a different authentication method (e.g., username/password, phone-number authentication (using SMS code), biometric identification such as fingerprints).

Each of partner networks 4 and 6 then independently sends its own transaction-detail portion to consumer transaction device 8 via the cyber-notary app (Step 26). The cyber-notary app enables the consumer to authenticate consumer transaction device 8 to partner networks 4 and 6, to view the transaction details, and to approve/decline the transaction.

The transaction details are then decrypted and reassembled (as detailed above) in the cyber-notary app and displayed to transaction consumer (Step 28). The transaction consumer then approves or declines the transaction in the cyber-notary app (Step 30). The cyber-notary app then sends a response (i.e., approved or declined) to each of partner networks 4 and 6 (Step 32). At this point in the process, each of partner networks 4 and 6 has a consumer approval/disapproval response of the transaction.

Each of partner networks 4 and 6 then separately notifies transaction provider 2 of the approval status (Step 34). Finally, each of partner networks 4 and 6 maintains a copy of its transaction-data portion with the transaction-consumer response (Step 36). Each of transaction provider 2 and the transaction consumer has unique links to the transaction-data portions saved on partner networks 4 and 6, which connects to the transaction that was saved on the systems of transaction provider 2.

It is noted that when validating a transaction, each party (i.e., transaction provider 2 and consumer transaction device 8) can validate the transaction with the third party (i.e., the cyber-notary) in order to ensure the transaction matches its expectations. For example, a bank (i.e., transaction provider 2 of FIG. 1) can reassemble the transaction (using the links and process mentioned above), and validate that the transaction is as expected. Such a reassembly process would reveal whether any portions from the partner networks were falsified, damaged, or otherwise modified. Likewise, such processes can reveal a transaction that was damaged, corrupted, or modified on the transaction-providers network.

It is further noted that implementations may involve several transaction consumers going through the cyber-notary process described above in order to obtain a final transaction approval. For example, an organization may have several managers (e.g., CEO, CFO, and Chairman of the Board) be required (or at least a critical subset of such authorizing agents/consumers) to provide a transaction approval for the transaction provider to ultimately authorize a transaction.

While the present invention has been described with respect to a limited number of embodiments, it will be appreciated that many variations, modifications, and other applications of the present invention may be made.

1. A method for protecting digital transactions, involving interactions and/or exchanges that require an approval between parties, using a zero-knowledge cyber-notary, the method comprising the steps of:
a) upon receiving a transaction request for securely performing a transaction wherein said transaction request includes transaction details, cryptographically splitting said transaction details into at least two data portions;
b) independently sending at least two exclusive unique portions of said at least two data portions exclusively to each of an array of at least two independent partner networks; wherein a given said exclusive unique portion, of said at least two exclusive unique portions, of a given said independent partner network, is neither:
i) sent, neither whole nor in part, to another said independent partner network other than said given independent partner network; nor
ii) accessible, neither whole nor in part, to said another independent partner network other than said given independent partner network;
c) upon each said independent partner network of said array independently identifying and authenticating a transaction consumer device associated with said transaction request, enabling said transaction consumer device to independently receive said at least two data portions from said each independent partner network of said array;
d) enabling reassembly of said at least two data portions on said transaction consumer device to produce said transaction details;
e) enabling an approval/disapproval response of said transaction request to be entered on said transaction consumer device;
f) enabling independent transmittal of said approval/disapproval response from said transaction consumer device to said each independent partner network of said array;
g) authorizing said transaction request based on receiving approval responses from an approval subset of at least two said approval/disapproval responses from said at least two independent partner networks of said array; and
h) declining said transaction request based on receiving disapproval responses from a disapproval subset of said at least two approval/disapproval responses from said at least two independent partner networks of said array.

2-3. (canceled)

4. The method of claim 1, wherein said each independent partner network neither receives nor has access to, neither whole nor in part, to said transaction details.

5. The method of claim 1, wherein said reassembly of said at least two data portions into said transaction details requires all said data portions from said each independent partner network of said array.

6. The method of claim 1, wherein any said data portion cannot be modified by any said independent partner network of said array without being detected.

7. The method of claim 1, wherein said step of independently sending includes independently sending a given, unique hash signature, of said another independent partner network other than said given independent partner network, to said given independent partner network.

8. (canceled)

9. The method of claim 1, the method further comprising the step of:
i) enabling subsequent reassembly of said at least two data portions for a historical transaction record to produce said transaction details of said historical transaction record.

10. A system for protecting digital transactions, involving interactions and/or exchanges that require an approval between parties, using a zero-knowledge cyber-notary, the system comprising:
a) a CPU for performing computational operations;
b) a memory module for storing data;
c) a network connection for communicating across a data-exchange protocol system; and
d) a cyber-notary module configured for:
i) upon receiving a transaction request for securely performing a transaction wherein said transaction request includes transaction details, cryptographically splitting said transaction details into at least two data portions;
ii) independently sending at least two exclusive unique portions of said at least two data portions exclusively to each of an array of at least two independent partner networks; wherein a given said exclusive unique portion, of said at least two exclusive unique portions, of a given said independent partner network, is neither:
A) sent, neither whole nor in part, to another said independent partner network other than said given independent partner network; nor
B) accessible, neither whole nor in part, to said another independent partner network other than said given independent partner network;
iii) upon each said independent partner network of said array independently identifying and authenticating a transaction consumer device associated with said transaction request, enabling said transaction consumer device to independently receive said at least two data portions from said each independent partner network of said array;
iv) enabling reassembly of said at least two data portions on said transaction consumer device to produce said transaction details;
v) enabling an approval/disapproval response of said transaction request to be entered on said transaction consumer device;
vi) enabling independent transmittal of said approval/disapproval response from said transaction consumer device to said each independent partner network of said array;
vii) authorizing said transaction request based on receiving approval responses from an approval subset of at least two said approval/disapproval responses from said at least two independent partner networks of said array; and
viii) declining said transaction request based on receiving disapproval responses from a disapproval subset of said at least two approval/disapproval responses from said at least two independent partner networks of said array.

11-12. (canceled)

13. The system of claim 10, wherein said each independent partner network neither receives nor has access to, neither whole nor in part, to said transaction details.

14. The system of claim 10, wherein said reassembly of said at least two data portions into said transaction details requires all said data portions from said each independent partner network of said array.

15. The system of claim 10, wherein any said data portion cannot be modified by any said independent partner network of said array without being detected.

16. The system of claim 10, wherein said independently sending includes independently sending a given, unique hash signature, of said another independent partner network other than said given independent partner network, to said given independent partner network.

17. (canceled)

18. The system of claim 10, wherein said cyber-notary module is further configured for:
ix) enabling subsequent reassembly of said at least two data portions for a historical transaction record to produce said transaction details of said historical transaction record.

19. A non-transitory computer-readable storage medium, having computer-readable code embodied on the non-transitory computer-readable storage medium, for protecting digital transactions, involving interactions and/or exchanges that require an approval between parties, using a zero-knowledge cyber-notary, the computer-readable code comprising:
a) program code for, upon receiving a transaction request for securely performing a transaction wherein said transaction request includes transaction details, cryptographically splitting said transaction details into at least two data portions;
b) program code for independently sending at least two exclusive unique portions of said at least two data portions exclusively to each of an array of at least two independent partner networks; wherein a given said exclusive unique portion, of said at least two exclusive unique portions, of a given said independent partner network, is neither:
i) sent, neither whole nor in part, to another said independent partner network other than said given independent partner network; nor
ii) accessible, neither whole nor in part, to said another independent partner network other than said given independent partner network;
c) program code for, upon each said independent partner network of said array independently identifying and authenticating a transaction consumer device associated with said transaction request, enabling said transaction consumer device to independently receive said at least two data portions from said each independent partner network of said array;
d) program code for enabling reassembly of said at least two data portions on said transaction consumer device to produce said transaction details;
e) program code for enabling an approval/disapproval response of said transaction request to be entered on said transaction consumer device;
program code for enabling independent transmittal of said approval/disapproval response from said transaction consumer device to said each independent partner network of said array;
g) program code for authorizing said transaction request based on receiving approval responses from an approval subset of at least two said approval/disapproval responses from said at least two independent partner networks of said array; and
h) program code for declining said transaction request based on receiving disapproval responses from a disapproval subset of said at least two approval/disapproval responses from said at least two independent partner networks of said array.

20-21. (canceled)

22. The non-transitory computer-readable storage medium of claim 19, wherein said each independent partner network neither receives nor has access to, neither whole nor in part, to said transaction details.

23. The non-transitory computer-readable storage medium of claim 19, wherein said reassembly of said at least two data portions into said transaction details requires all said data portions from said each independent partner network of said array.

24. The non-transitory computer-readable storage medium of claim 19, wherein any said data portion cannot be modified by any said independent partner network of said array without being detected.

25. The non-transitory computer-readable storage medium of claim 19, wherein said independently sending includes independently sending a given, unique hash signature, of said another independent partner network other than said given independent partner network, to said given independent partner network.

26. (canceled)

27. The non-transitory computer-readable storage medium of claim 19, the computer-readable code further comprising:
i) program code for enabling subsequent reassembly of said at least two data portions for a historical transaction record to produce said transaction details of said historical transaction record.

28. The method of claim 1, wherein said step of authorizing is configured such that each said at least two independent partner networks cannot independently become a fraudulent party by modifying said at least two exclusive unique portions, and wherein said step of declining is configured such that each said at least two independent partner networks cannot independently become a fraudulent party by modifying said at least two exclusive unique portions.

29. The method of claim 28, wherein a respective given, unique hash signature of said given exclusive unique portion of said given independent partner network is exclusively saved on another said independent partner network other than said given independent partner network in order to prevent said given independent partner network from becoming a fraudulent party.

30. The system of claim 10, wherein said authorizing is configured such that each said at least two independent partner networks cannot independently become a fraudulent party by modifying said at least two exclusive unique portions, and wherein said declining is configured such that each said at least two independent partner networks cannot independently become a fraudulent party by modifying said at least two exclusive unique portions.

31. The system of claim 30, wherein a respective given, unique hash signature of said given exclusive unique portion of said given independent partner network is exclusively saved on another said independent partner network other than said given independent partner network in order to prevent said given independent partner network from becoming a fraudulent party.

32. The non-transitory computer-readable storage medium of claim 19, wherein said authorizing is configured such that each said at least two independent partner networks cannot independently become a fraudulent party by modifying said at least two exclusive unique portions, and wherein said declining is configured such that each said at least two independent partner networks cannot independently become a fraudulent party by modifying said at least two exclusive unique portions.

33. The non-transitory computer-readable storage medium of claim 32, wherein a respective given, unique hash signature of said given exclusive unique portion of said given independent partner network is exclusively saved on another said independent partner network other than said given independent partner network in order to prevent said given independent partner network from becoming a fraudulent party.
